(19) United States
(12) Patent Application Publication
(10) Pub. No.: US 2015/0288830 A1
(43) Pub. Date: Oct. 8, 2015

(54) APPARATUS AND METHOD FOR CONTROLLING RINGTONE AND VIBRATION AUTOMATICALLY

(71) Applicant: ELECTRONICS AND TELECOMMUNICATIONS RESEARCH INSTITUTE, Daejeon (KR)

(72) Inventors: Nam Seok KO, Daejeon (KR); Sung Kee NOH, Daejeon (KR)

(21) Appl. No.: 14/663,611

(22) Filed: Mar. 20, 2015

(30) Foreign Application Priority Data
Apr. 7, 2014 (KR) 10-2014-0041023

(51) Int. Cl. H04M 19/04; H04W 88/02

(52) U.S. Cl. CPC H04M 19/042; H04W 88/02; H04M 19/047

(57) ABSTRACT

An apparatus for controlling a ringtone and vibration automatically, which includes: a user volume controlling unit which sets an output level of a receiving ringtone of a portable device through an operation of a user; a ringtone generating unit which generates a signal for determining the output level of the ringtone according to the setting of the user volume controlling unit; a speaker which receives the signal of the ringtone generating unit and outputs the ringtone at the output level depending on the signal; a microphone which receives the ringtone output through the speaker; and a processing unit which compares a reception level of the ringtone received through the microphone and the output level of the signal or the speaker, generates a control signal for controlling the output level based on a result of the comparison, and outputs the control signal to the ringtone generating unit.

### CROSS-REFERENCE TO RELATED APPLICATIONS

This application claims priority to and the benefit of Korean Patent Application No. 10-2014-0041023 filed in the Korean Intellectual Property Office on Apr. 7, 2014, the entire contents of which are incorporated herein by reference.

### TECHNICAL FIELD

The present invention relates to an apparatus and a method for controlling a ringtone and vibration automatically, and more particularly, to an apparatus and a method for controlling a ringtone and vibration automatically, which automatically controls a level of a ringtone and generation of vibration depending on a place in which a portable device is located.

### BACKGROUND ART

With a rapid increase of using portable devices, the portable device has become a daily necessity of people these days. The portable device provides a communication environment which is free from the limits of time and space in which a user is located, but since the portable device is frequently changed according to a user's movement, the corresponding portable device may not appropriately cope with the environmental changes.

As the environment around the portal device changes, one of the required setting changes for the portable device is related to the receiving call setting. The setting of a volume of ringtone, which notifies a receiving call to a user, is extremely sensitive according to where the user is located. A user could be located in a comparatively silent place, such as a school, a workplace, a home, or the like, but may be located in a comparatively noisy environment such as a very crowded street.

The appropriate volume setting of the portable device according to the changes of the places may be a significant burden to a user, and many users generally fix the ringtone volume of their portable device to a predetermined level. Therefore, when the portable device is located in a closed place such as inside a pocket of trousers or inside a bag of a user, the user may not recognize ringtone from the portable device if the volume setting is set to a lower level.

### SUMMARY OF THE INVENTION

The present invention has been made in an effort to provide an apparatus and a method for controlling a ringtone and vibration automatically, which automatically control a level of the ringtone and whether the vibration is generated depending on a place in which a portable device is located.

An exemplary embodiment of the present invention provides an apparatus for controlling a ringtone and vibration automatically, which includes: a user volume controlling unit which sets an output level of a receiving ringtone of a portable device through an operation by a user; a ringtone generating unit which generates a signal for determining the output level of the ringtone according to the setting by the user volume controlling unit; a speaker which receives the signal of the ringtone generating unit and outputs the ringtone at the output level depending on the signal; a microphone which receives the ringtone output through the speaker; and a processing unit which compares a reception level of the ringtone received through the microphone and the output level of the signal or the speaker, generates a control signal for controlling the output level based on a result of the comparison, and outputs the control signal to the ringtone generating unit.

The apparatus may further include a coupling circuit receiving the output of the user volume controlling unit and the control signal of the processing unit, and synthesizing the received output of the user volume controlling unit and the control signal of the processing unit to transfer the synthesized output and control signal to the ringtone generating unit.

The apparatus may further include an amplifier receiving the signal of the ringtone generating unit and the control signal of the processing unit, and determining an amplification degree of the output level of the ringtone to control the speaker based on the signal of the ringtone generating unit and the control signal of the processing unit.

The processing unit may generate a control signal for increasing the output level of the ringtone when the reception level is smaller than the signal or the output level as the result of comparison.

The processing unit may generate a control signal for decreasing the output level of the ringtone when the reception level is larger than the signal or the output level as the result of comparison.

The apparatus may further include a vibration generating unit connected with the processing unit and controlling vibration of the portable device according to the output of the processing unit, and the processing unit may additionally generate and output a vibration control signal for controlling the generation of the vibration and the intensity of the vibration when the reception level is smaller than the signal or the output level through comparison with a predetermined level as the result of comparison.

Another exemplary embodiment of the present invention provides a method for controlling a ringtone and vibration automatically, including: receiving a ringtone of a portable device, which is output through a speaker comprised in the portable device; calculating a reception level, of the received ringtone; calculating an output level of the ringtone output through the speaker; comparing the reception level and the output level; and controlling the output level of the ringtone according to a result of the comparison.

The controlling the output level of the ringtone according to a result of the comparison may include increasing the output level of the ringtone when the reception level is smaller than the output level as the result of comparison.

The controlling the output level of the ringtone according to a result of the comparison may include decreasing the output level of the ringtone when the reception level is larger than the output level as the result of comparison.

The method may further include controlling the generation of the vibration and the intensity of the vibration and the intensity of the vibration of the portable device when the reception level is smaller than the signal or the output level through comparison with a predetermined level as the result of comparison.

According to exemplary embodiments of the present invention, an apparatus and a method for controlling a ringtone and vibration automatically can automatically control a level of the ringtone and whether vibration is generated depending on a place in which a portable device is located.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

Objects of the present invention are not limited the aforementioned object and other objects and advantages of the present invention, which are not mentioned can be appreciated by the following description and will be more apparently know by the exemplary embodiments of the present invention. It can be easily known that the objects and advantages of the present invention can be implemented by the means and a combination thereof described in the appended claims.

### BRIEF DESCRIPTION OF THE DRAWINGS

FIG. 1 is a diagram illustrating the case in which a portable device is located in a pocket of trousers of a user or on a desk.

FIG. 2 is a diagram generally illustrating a content of controlling a ringtone of the portable device.

FIG. 3 is a diagram illustrating an apparatus for controlling a ringtone and vibration automatically according to an exemplary embodiment of the present invention.

FIG. 4 is a diagram illustrating an apparatus for controlling a ringtone and vibration automatically according to another exemplary embodiment of the present invention.

FIG. 5 is a diagram illustrating an apparatus for controlling a ringtone and vibration automatically according to yet another exemplary embodiment of the present invention.

FIG. 6 is a diagram illustrating an apparatus for controlling a ringtone and vibration automatically according to still another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Various advantages and features of the present invention and methods accomplishing thereof will become described from the following description of embodiments with reference to the accompanying drawings. However, the present invention is not limited to exemplary embodiments described herein and may be implemented in other forms. However, the exemplary embodiments are provided to those skilled in the art to describe the technical spirit specifically enough to easily execute the technical spirit of the present invention.

In the drawings, the exemplary embodiments of the present invention are limited to an illustrated specific form and exaggerated for clarity. Specific terms are used in the specification, but the specific terms are used for describing the present invention and not used to limit a meaning or limit the scope of the present invention disclosed in the claims.

In the specification, an expression of ‘and/or’ is used as a meaning including at least one of components arranged front and rear. Further, an expression of ‘connected/coupled’ is used as a meaning including directly connected with another component or indirectly connected through another component. Unless particularly stated otherwise in the present specification, a singular form also includes a plural form. Further, a component, a step, an operation, and an element mentioned as ‘include’ or ‘including’ mean presence or addition of one or more other components, steps, operations, and elements.

Hereinafter, exemplary embodiments of the present invention will be described in detail with reference to the accompanying drawings.

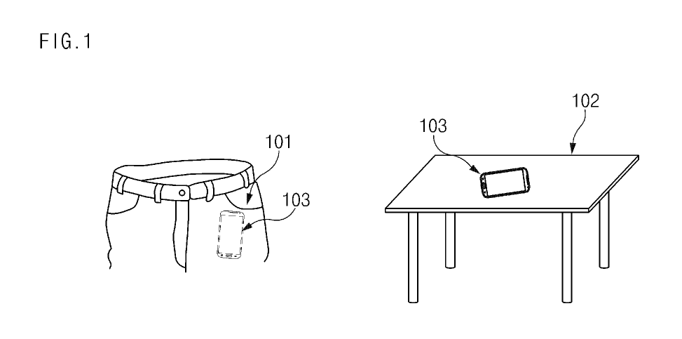

FIG. 1 is a diagram illustrating the case in which a portable device is located in a pocket of trousers of a user or on a desk.

The portable device may be devices such as a smart phone and a tablet PC having a function of a cellular phone and hereinafter, the portable device will be described as the cellular phone which is a representative example of the portable, device for easy description. However, this is for easy description and the scope of the present invention is not limited to the cellular phone.

A user generally keeps carrying a cellular phone 103 in his or her daily life. The user could carry the cellular phone 103 in different places such as a pocket or a bag of the user and as a representative example, the user may put the cellular phone 103 in a pocket of trousers 101 of the user. In addition, when the user stays at a specific place, the user may place the corresponding cellular phone 103 on a table 102.

Herein, when the cellular phone 103 is located inside the pocket of trousers 101 of the user, since the pocket of trousers 101 is a relatively closed space, the user may not recognize a receiving ringtone of the cellular phone 103. Similarly, even when the cellular phone 103 is placed on the table 102, if a surrounding environment of the table 102 is a case in which noise is generated, the user may not recognize the receiving ringtone of the cellular phone 103. In order to prevent such a problem, an output level of the ringtone of the corresponding cellular phone 103 is increased by an operation by the user and thereafter, the cellular phone 103 may be located in the pocket of trousers 101 or on the table 102 where the noise is generated, but such a process may be a very cumbersome process to the user.

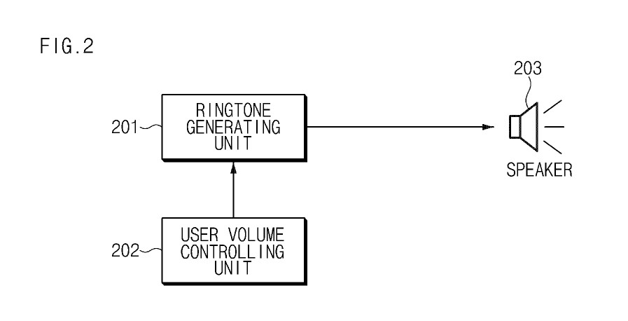

FIG. 2 is a diagram generally illustrating a content of controlling a ringtone of the cellular phone. Referring to FIG. 2, the ringtone of the cellular phone is controlled through a ringtone generating unit 201, a user volume controlling unit 202, and a speaker 203.

The ringtone generating unit 201 receives an output signal of the user volume controlling unit 202 controlling the output level of the ringtone through the operation by the user, and generates a signal for determining an output level of the ringtone depending on the received signal and transfers the generated signal to the speaker 203.

The speaker 203 receives an output of the ringtone generating unit 201 and outputs the ringtone at the determined output level of the ringtone.

Consequently, in a general process, the output level of the receiving ringtone of the cellular phone is determined only by the operation by the user regardless of a surrounding circumstance or a place in which the corresponding cellular phone is located.

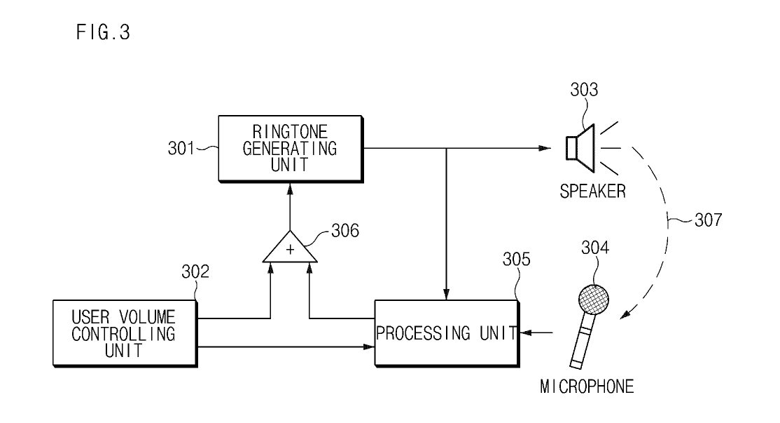

FIG. 3 is a diagram illustrating an apparatus for controlling a ringtone and vibration automatically according to an exemplary embodiment of the present invention. Referring to FIG. 3, the apparatus for controlling a ringtone and vibration automatically may further include a ringtone generating unit 301, a user volume controlling unit 302, a speaker 303, a microphone 304, and a processing unit 305 and may further include a coupling circuit 306.

The user volume controlling unit 302 sets the output level of the receiving ringtone of the cellular phone to a level of the corresponding cellular phone desired by the user. In addition, a signal regarding the set output level is transferred to the ringtone generating unit 301.

The ringtone generating unit 301 receives the signal regarding the output level of the ringtone set by the user volume controlling unit 302, and generates the signal for determining the output level of the ringtone of the cellular phone according to the received signal and transfers the generated signal to the speaker 303.

The speaker 303 receives the signal for determining the output level of the ringtone generated and transferred by the ringtone generating unit 301 and outputs the receiving ringtone of the corresponding cellular phone at the output level determined according to the corresponding signal.

The microphone 304 receives the ringtone output from the speaker 303 (307) and transfers the received ringtone to the processing unit 305.

The processing unit 305 compares a reception level of the ringtone transferred through the microphone 304 with the output level of the ringtone output through the speaker 303. A level of the ringtone actually recognized by the user is regarded as a reception level of the ringtone transferred from the microphone 304 and a level of the ringtone set by the user is regarded as the output level of the ringtone output through the speaker, and the reception level and the output level are compared with each other. Herein, the processing unit 305 may determine the level of the ringtone set by the user through the signal generated by the ringtone generating unit 301 and as another method, the processing unit 305 may determine the level of the ringtone through the signal regarding the output level set by the user in the user volume controlling unit 302.

Further, the processing unit 305 determines the place in which the corresponding cellular phone is located at present through a result of comparing the reception level of the ringtone and the output level of the ringtone. In addition, the processing unit 305 generates and outputs a control signal for controlling the output level of the receiving ringtone of the corresponding cellular phone according to the determination result.

The cases which may occur are described in detail, as the result of comparing the reception level of the ringtone and the output level of the ringtone in the processing unit 305. If the reception level actually received through the microphone 304 is smaller than the output level output through the speaker 303, it is determined that the case is as a situation in which it is difficult for the user to recognize the receiving ringtone of the cellular phone, and as a result, the processing unit 305 generates and outputs a control signal for increasing the output level of the ringtone of the cellular phone. On the contrary, as the result of comparing the reception level of the ringtone and the output level of the ringtone, in the case where the reception level of signal which is actually received through the microphone 304 is larger than the output level from the speaker 303, it is determined that the case is as a case where the receiving ringtone of the cellular phone is excessively larger than the ringtone recognized by the user, and as a result, the processing unit 305 generates and outputs a control signal for decreasing the output level of the ringtone of the cellular phone. Herein, a degree of increasing or decreasing the output level of the ringtone may be determined by using a specific function or a mapping table in which values to add and subtract the ringtone are, in advance, mapped according to a ratio of the reception level of the ringtone transferred through the microphone 304 and the output level of the ringtone output through the speaker 303.

The apparatus may further include the coupling circuit 306 in order to more efficiently input and output signals among the ringtone generating unit 301, the user volume controlling unit 302 and the processing unit 305. Herein, the coupling circuit 306 is positioned among the ringtone generating unit 301, the user volume controlling unit 302, and the processing unit 305 to receive the output of the user volume controlling unit 302 and the control signal of the processing unit 305, synthesize the received output of the user volume controlling unit 302 and the control signal of the processing unit 305, and transfer the synthesized signal to the ringtone generating unit 301.

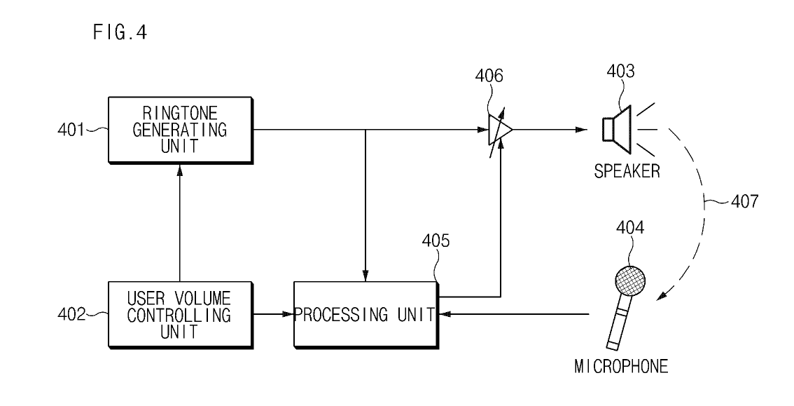

FIG. 4 is a diagram illustrating an apparatus for controlling a ringtone and vibration automatically according to another exemplary embodiment of the present invention. Referring to FIG. 4, the apparatus for controlling a ringtone and vibration automatically may further include a ringtone generating unit 401, a user volume controlling unit 402, a speaker 403, a microphone 404, and a processing unit 405 and may further include an amplifier 406.

Since the ringtone generating unit 401, the user volume controlling unit 402, the speaker 403, and the microphone 404 of FIG. 4 are the same as the ringtone generating unit 301, the user volume controlling unit 302, the speaker 303, and the microphone 304 of FIG. 3, a detailed description thereof will be omitted.

The processing unit 405 of FIG. 4 compares the reception level of the ringtone transferred through the microphone 404 and the output level of the ringtone output through the speaker 403 like the processing unit 305. Herein, the processing unit 405 may determine the level of the ringtone set by the user through the signal generated by the ringtone generating unit 401 similarly as the processing unit 305 of FIG. 3 and as another method, the processing unit 402 may determine the level of the ringtone through the signal regarding the output level set by the user in, the user volume controlling unit 402. However, the processing unit 405 of FIG. 4 is different from the processing unit 305 of FIG. 3 in that the control signal for controlling the output level of the receiving ringtone of the cellular phone is transferred to not the ringtone generating unit 401 but the amplifier 406 according to the result of comparison and the location of the corresponding cellular phone and the output level of the ringtone output to the speaker 403 is controlled through the control signal.

Herein, the amplifier 406 receives the signal of the ringtone generating unit 401 and the control signal of the processing unit 405 and determines an amplification degree of the output level of the ringtone output to the speaker 403 to control the speaker 403 based on the signal of the ringtone generating unit 401 and the control signal of the processing unit 405 which are received.

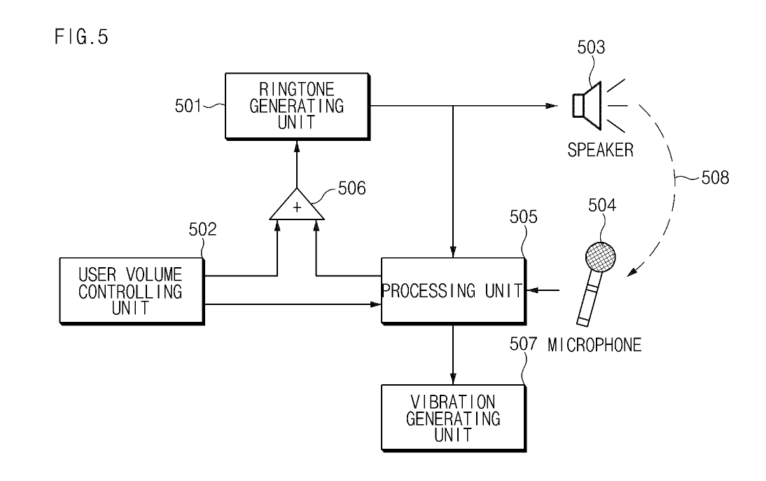

FIG. 5 is a diagram illustrating an apparatus for controlling a ringtone and vibration automatically according to yet another exemplary embodiment of the present invention. Referring to FIG. 5, the apparatus for controlling a ringtone and vibration automatically may further include a ringtone generating unit 501, a user volume controlling unit 502, a speaker 503, a microphone 504, a processing unit 505, and a vibration generating unit 507. In addition, the apparatus may further include a coupling circuit 506 similarly as the apparatus in FIG. 3.

Since the ringtone generating unit 501, the user volume controlling unit 502, the speaker 503, and the microphone 504 of FIG. 5 are the same as the ringtone generating unit 301, the user volume controlling unit 302, the speaker 303, and the microphone 304 of FIG. 3, a detailed description thereof will be omitted.

The apparatus for controlling a ringtone and vibration automatically of FIG. 5 further includes the vibration generating unit 507 as compared with the apparatus in FIG. 3. Herein, the vibration generating unit 507 is connected with the processing unit 505, receives an output of the processing unit 505, and controls vibration of the portable device according to the received output.

The processing unit 505 of FIG. 5 compares the reception level of the ringtone transferred through the microphone 504 and the output level of the ringtone output through the speaker 503 like the processing unit 305. Herein, the processing unit 505 may determine the level of the ringtone set by the user through the signal generated by the ringtone generating unit 501 similarly as the processing unit 305 of FIG. 3 and as another method, the processing unit 502 may determine the level of the ringtone through the signal regarding the output level set by the user in the user volume controlling unit 502. However, the processing unit 505 of FIG. 5 is different from the processing unit 305 of FIG. 3 in that the processing unit 505 additionally generates and outputs a vibration control signal for controlling the vibration of the cellular phone.

In detail, as a result of comparing the reception level of the ringtone transferred through the microphone 504 and the output level of the ringtone output through the speaker 503, when a degree in which the reception level is smaller than the signal or the output level is smaller than a predetermined level, the processing unit 505 determines that the user is not able to recognize an incoming call of the cellular phone or not by only an increase in output level of the ringtone. Therefore, the processing unit 505 allows the user to recognize the incoming call of the cellular phone or not by generating the vibration of the cellular phone together with the increase in output level of the ringtone. To this end, the processing unit 505 additionally generates and outputs the vibration control signal for controlling the generation of the vibration or the intensity of the vibration. Herein, the generation of the vibration may include controlling the intensity of the corresponding vibration when the vibration is set as well as generating the vibration when the vibration is not set.

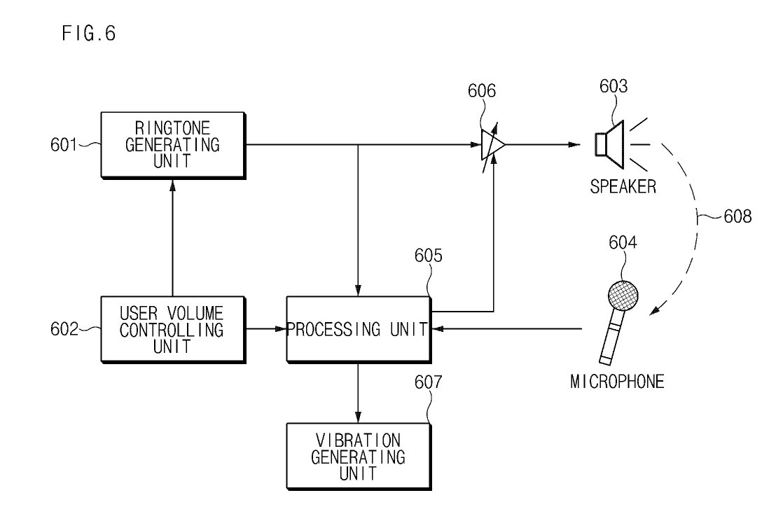

FIG. 6 is a diagram illustrating an apparatus for controlling a ringtone and vibration automatically according to still another exemplary embodiment of the present invention. Referring to FIG. 6, the apparatus for controlling a ringtone and vibration automatically may further include a ringtone generating unit 601, a user volume controlling unit 602, a speaker 603, a microphone 604, a processing unit 605, and a vibration generating unit 607. In addition, the apparatus may further include an amplifier 606 similarly as the apparatus in FIG. 4.

Since the ringtone generating unit 601, the user volume controlling unit 602, the speaker 603, and the microphone 604 of FIG. 6 are the same as the ringtone generating unit 401, the user volume controlling unit 402, the speaker 403, and the microphone 404 of FIG. 4, a detailed description thereof will be omitted.

The apparatus for controlling a ringtone and vibration automatically of FIG. 6 further includes a vibration generating unit 607 as compared with the apparatus in FIG. 4. Herein, the vibration generating unit 607 is connected with the processing unit 605, receives an output of the processing unit 605, and controls vibration of the portable device according to the received output.

The processing unit 605 of FIG. 6 compares the reception level of the ringtone transferred through the microphone 604 and the output level of the ringtone output through the speaker 603 like the processing unit 405 of FIG. 4. Herein, the processing unit 605 may determine the level of the ringtone set by the user through the signal generated by the ringtone generating unit 601 similar to the processing unit 405 of FIG. 4 and as another method, the processing unit 605 may determine the level of the ringtone through the signal regarding the output level set by the user in the user volume controlling unit 602. However, the processing unit 605 of FIG. 6 is different from the processing unit 405 of FIG. 4 in that the processing unit 605 additionally generates and outputs a vibration control signal for controlling the vibration of the cellular phone.

In detail, as a result of comparing the reception level of the ringtone transferred through the microphone 604 and the output level of the ringtone output through the speaker 603, when a degree in which the reception level is smaller than the signal or the output level is smaller than a predetermined level, the processing unit 605 determines that the user is not able to recognize an incoming call of the cellular phone or not by only an increase in output level of the ringtone. Therefore, the processing unit 605 allows the user to recognize the incoming call of the cellular phone or not by generating the vibration of the cellular phone together with the increase in output level of the ringtone. To this end, the processing unit 605 additionally generates and outputs the vibration control signal for controlling the generation of the vibration or the magnitude of the vibration. Herein, the generation of the vibration may include controlling the intensity of the corresponding vibration when the vibration is set as well as generating the vibration when the vibration is not set.

Hereinafter, a method for controlling a ringtone and vibration automatically according to yet another exemplary embodiment of the present invention will be described.

First, when a call comes in a cellular phone, a ringtone of the cellular phone, which is output through a speaker provided in the cellular phone is received.

Thereafter, a reception level of the received ringtone is calculated and an output level of the ringtone output through the speaker is calculated.

In addition, the calculated reception level of the ringtone and the calculated output level of the ringtone are compared with each other.

Thereafter, according to a result of the comparison, the output level of the ringtone generated from the cellular phone is controlled. Herein, when the control of the output level of the ringtone according to the result of comparison is described in more detail, when the reception level is smaller than the output level as the result of comparing the reception level and the output level, the output level of the ringtone of the cellular phone is increased. On the contrary, when the reception level is larger than the output level as the result of comparing the reception level and the output level, the output level of the ringtone of the cellular phone is decreased.

In addition, in the method for controlling a ringtone and vibration automatically according to yet another exemplary embodiment of the present invention, as the result of comparing the reception level and the output level, when the reception level is smaller than the output level as compared with a predetermined level, vibration of the cellular phone may be generated or the intensity of the vibration may be controlled together with the increase in ringtone of the cellular phone.

Consequently, according to the method for controlling a ringtone and vibration automatically according to yet another exemplary embodiment of the present invention, by comparing a level of the ringtone of the cellular phone, which is actually recognized by a user and a predetermined level of the ringtone with each other, when the level of the ringtone of the cellular phone, which is actually recognized by the user is the smaller, the output level of the corresponding ringtone is increased and in addition, the generation of the vibration is also controlled to automatically change the output level of the ringtone and the vibration depending on a place in which the cellular phone is located. As a result, the user of the cellular phone may accurately recognize the incoming call of the cellular phone or not regardless of the place in which the corresponding cellular phone is located.

Various exemplary embodiments of the present invention have been just exemplarily described, and various changes and modifications may be made by those skilled in the art to which the present invention pertains without departing from the scope and spirit of the present invention. Accordingly, the embodiments disclosed herein are intended not to limit but to describe the technical spirit of the present invention, and the scope of the technical spirit of the present invention is not limited to the embodiments. The scope of the present invention may be interpreted by the appended claims and all the technical spirit in the equivalent range thereto are intended to be embraced by the claims of the present invention.

What is claimed is:

1. An apparatus for controlling a ringtone and vibration automatically, comprising:
a user volume controlling unit which sets an output level of a receiving ringtone of a portable device through an operation by a user;
a ringtone generating unit which generates a signal for determining the output level of the ringtone according to the setting by the user volume controlling unit;
a speaker which receives the signal of the ringtone generating unit and outputs the ringtone at the output level depending on the signal;
a microphone which receives the ringtone output through the speaker; and
a processing unit which compares a reception level of the ringtone received through the microphone and the output level of the signal or the speaker, generates a control signal for controlling the output level based on a result of the comparison, and outputs the control signal to the ringtone generating unit.

2. The apparatus of claim 1, further comprising:
a coupling circuit which receives the output of the user volume controlling unit and the control signal of the processing unit, and synthesizes the received output of the user volume controlling unit and the control signal of the processing unit to transfer the synthesized output and control signal to the ringtone generating unit.

3. The apparatus of claim 1, further comprising;
an amplifier which receives the signal of the ringtone generating unit and the control signal of the processing unit, and determines an amplification degree of the output level of the ringtone to control the speaker based on the signal of the ringtone generating unit and the control signal of the processing unit.

4. The apparatus of claim 1, wherein the processing unit generates a control signal for increasing the output level of the ringtone when the reception level is smaller than the signal or the output level.

5. The apparatus of claim 1, wherein the processing unit generates a control signal for decreasing the output level of the ringtone when the reception level is larger than the signal or the output level.

6. The apparatus of claim 4, further comprising:
a vibration generating unit which is connected with the processing unit and controlling vibration of the portable device according to the output of the processing unit,
wherein the processing unit additionally generates and outputs a vibration control signal for controlling the generation of the vibration and the intensity of the vibration when the reception level is smaller than the signal or the output level through comparison with a predetermined level.

7. A method for controlling a ringtone and vibration automatically, the method comprising:
receiving a ringtone of a portable device, which is output through a speaker comprised in the portable device;
calculating a reception level of the received ringtone;
calculating an output level of the ringtone output through the speaker;
comparing the reception level and the output level; and
controlling the output level of the ringtone according to a result of the comparison.

8. The method of claim 7, wherein the controlling the output level of the ringtone according to a result of the comparison includes increasing the output level of the ringtone when the reception level is smaller than the output level.

9. The method of claim 7, wherein the controlling the output level of the ringtone according to a result of the comparison includes decreasing the output level of the ringtone when the reception level is larger than the output level.

10. The method of claim 8, further comprising:
controlling the generation of the vibration and the intensity of the vibration of the portable device when the reception level is smaller than the signal or the output level through comparison with a predetermined level.
